(19) United States
(12) Patent Application Publication
(10) Pub. No.: US 2012/0277370 A1
(43) Pub. Date: Nov. 1, 2012

(54) ROOM TEMPERATURE CURABLE ORGANOPOLYSILOXANE COMPOSITION

(75) Inventors: Takafumi SAKAMOTO, Annaka-shi (JP); Masayuki Ikeno, Annaka-shi (JP)

(73) Assignee: Shin-Etsu Chemical Co., Ltd., Chiyoda-ku (JP)

(21) Appl. No.: 13/455,487

(22) Filed: Apr. 25, 2012

(30) Foreign Application Priority Data
Apr. 28, 2011 (JP) 2011-101233

(51) Int. Cl. C08L 83/08; C08G 77/26

(52) U.S. Cl. 524/588; 528/33; 525/477; 528/18

(57) ABSTRACT

A room temperature curable organopolysiloxane composition is provided. The composition contains a diorganopolysiloxane having at least two groups represented by the following formula (1):

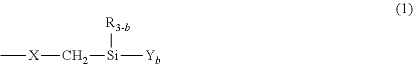

per molecule as its main component. In the formula, X is —R′_{d}—NH— or —R′_{d}—S—, R is a substituted or unsubstituted C₁₋₁₂ monovalent hydrocarbon group, R′ is a C₁₋₈ divalent hydrocarbon group, Y is a hydrolyzable group, b is 2 or 3, and d is 0 or 1. The composition has excellent room temperature curability, and the cured product has excellent moisture resistance. The composition is useful as an adhesive or sealant used at a site where hardness, water resistance, and moisture resistance are required, and in particular, for an adhesive in construction applications and electric and electronic applications where steam resistance and water resistance are required.

### CROSS-REFERENCE TO RELATED APPLICATION

This non-provisional application claims priority under 35 U.S.C. §119(a) on Patent Application No. 2011-101233 filed in Japan on Apr. 28, 2011, the entire contents of which are hereby incorporated by reference.

### TECHNICAL FIELD

This invention relates to a room temperature curable organopolysiloxane composition, and more specifically, to a room temperature curable organopolysiloxane composition which has improved curability and storage stability, and which is capable of providing a cured product having high resistance to moisture and water.

### BACKGROUND ART

Various types of room temperature curable organopolysiloxane compositions which cure at room temperature into elastomeric state by exposure to moisture in the air have been known in the art, and the type which cures by releasing alcohol are suitable for sealing, adhesion, and coating of electric and electronic devices since they have no unpleasant odor and they do not corrode metals.

Typical examples of such type include a composition comprising a hydroxy group-endcapped organopolysiloxane, an alkoxysilane, and an organotitanium compound disclosed in JP-B S39-27643. Furthermore, JP-A S55-43119 discloses a composition comprising an alkoxysilyl-endcapped organopolysiloxane, an alkoxysilane, and alkoxytitanium, and JP-B H07-39547 discloses a composition comprising an alkoxysilyl-endcapped straight chain organopolysiloxane containing silethylene group, an alkoxysilane, and an alkoxytitanium. Furthermore, JP-A H07-331076 discloses a composition comprising a hydroxy-endcapped organopolysiloxane or an alkoxy-endcapped organopolysiloxane and an alkoxy-α-silyl ester compound.

These compositions exhibit certain extent of storage stability, water resistance, and moisture resistance. However, curability is still insufficient, and the problem as described above is not yet sufficiently obviated.

### SUMMARY OF THE INVENTION

The present invention has been completed in view of the situation as described above, and an object of the present invention is to provide a room temperature curable organopolysiloxane composition having improved curability and storage stability and imparting a cured product having high resistance to moisture and water.

The inventors of the present invention conducted an intensive study for realizing such objects, and found that a structure having silmethylene skeleton represented by the following formula (1) is capable of remarkably improving the hydrolyzability, and use of a polymer having this group enables production of a room temperature curable organopolysiloxane composition having excellent room temperature curability and storage stability simultaneously with the merit that the cured product has high resistance to moisture and water. The present invention has been completed on the bases of such findings.

Accordingly, the present invention provides a room temperature curable organopolysiloxane composition comprising, as its main component, a diorganopolysiloxane having at least two groups represented by the following formula (1):

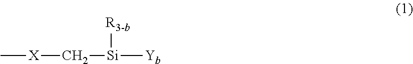

wherein X is —R′_{d}—NH— or —R′_{d}—S—, R is a substituted or unsubstituted monovalent hydrocarbon group containing 1 to 12 carbon atoms, R′ is a divalent hydrocarbon group containing 1 to 8 carbon atoms, Y is a hydrolyzable group, b is 2 or 3, and d is 0 or 1 per molecule.

The composition of the present invention may further comprise (B) a silane having at least 2 hydrolyzable groups bonded to the silicon atom per molecule and/or its partial hydrolytic condensate, (C) a filler, and (D) an organometallic catalyst in addition to the component (A).

### ADVANTAGEOUS EFFECTS OF INVENTION

The organopolysiloxane composition of the present invention has excellent room temperature curability, and the cured product has excellent moisture resistance. In addition, the composition after storing, for example, for 6 months will rapidly cure when exposed to air to exhibit excellent physical properties. This composition is useful as an adhesive or sealant for use at a place where hardness, water resistance, and moisture resistance are required, and in particular, for an adhesive in construction applications and electric and electronic applications where steam resistance and water resistance are required.

### DESCRIPTION OF THE PREFERRED EMBODIMENTS

Next, the present invention is described in detail.

The room temperature curable organopolysiloxane composition of the present invention contains a diorganopolysiloxane having at least two groups represented by the following formula (1) per molecule as its main component.

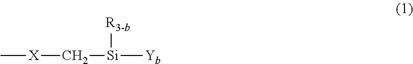

In the formula, X is —R′_{d}—NH— or —R′_{d}—S—, R is a substituted or unsubstituted monovalent hydrocarbon group containing 1 to 12 carbon atoms, R′ is a divalent hydrocarbon group containing 1 to 8 carbon atoms, Y is a hydrolyzable group, b is 2 or 3, and d is 0 or 1.

More preferably, the room temperature curable organopolysiloxane composition of the present invention further comprises

(B) a silane having at least 2 hydrolyzable groups bonded to the silicon atom per molecule and/or its partial hydrolytic condensate,

(C) a filler, and

(D) an organometallic catalyst.

### Component (A)

The diorganopolysiloxane of the component (A) is the main component (base polymer) of the room temperature curable organopolysiloxane composition of the present invention, and this component is critical for realizing the improvement of the room temperature curability which is an object of the present invention. The diorganopolysiloxane has at least two hydroxy groups or hydrolyzable groups bonded to the silicon atom per molecule, and this structure caps the polymer with the intervening methylene group. Conventional polymers that had been used had the hydroxy group or the hydrolyzable group with the intervening siloxane (oxygen atom) or ethylene group. However, the inventors of the present invention unexpectedly found that the room temperature curability is remarkably improved when the intervening group is methylene group. Exemplary such diorganopolysiloxanes include the diorganopolysiloxane represented by the following formula (2):

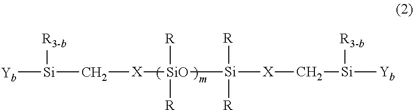

wherein X, R, Y, and b are as defined above, with the proviso that R′ in the X binds to the silicon atom when d is 1, and m is a number such that viscosity of the diorganopolysiloxane at 25° C. is 100 to 1,000,000 mPa·s.

Examples of the substituted or unsubstituted monovalent hydrocarbon group R in the formula include alkyl groups such as methyl group, ethyl group, propyl group, butyl group, pentyl group, hexyl group, heptyl group, octyl group, nonyl group, decyl group, and octadecyl group, cycloalkyl groups such as cyclopentyl group and cyclohexyl group, alkenyl groups such as vinyl group, allyl group, butenyl group, pentenyl group, and hexenyl group, aryl groups such as phenyl group, tolyl group, xylyl group, and α- and β-naphthyl groups, aralkyl groups such as benzyl group, 2-phenylethyl group, and 3-phenylpropyl group, and any of such groups having its hydrogen atoms partly or entirely substituted with a halogen atom such as F, Cl, or Br or cyano group, for example, 3-chloropropyl group, 3,3,3-trifluoropropyl group, or 2-cyanoethyl group. Among these, the preferred are methyl group and ethyl group, and the most preferred is methyl group.

X is a group represented by —R′_{d}1'NH— or —R′_{d}—S— wherein R′ is a divalent hydrocarbon group containing 1 to 8 carbon atoms such as methylene group, ethylene group, or propylene group, and preferably, an alkylene group containing 1 to 3 carbon atoms; and d is 0 or 1. Exemplary such groups include NH—, —S—, —NH—CH₂—, —NH—C₂H₄—, —S—CH₂—, —S—C₂H₄—, and —S—C₃H₆—. Exemplary structures with the adjacent methylene group, i.e., —CH₂—X—, include —CH₂—NH—, —CH₂—S—, —CH₂—NH—C₃H₆—, and —CH₂—S—C₂H₄—, and the preferred are —CH₂—NH— and —CH₂—NH—CH₄—.

Y is a hydrolyzable group at the end of the molecular chain of the diorganopolysiloxane, and examples include alkoxy groups such as methoxy group, ethoxy group, and propoxy group, alkoxyalkoxy groups such as methoxyethoxy group, ethoxyethocy group, and methoxypropoxy group, acyloxy groups such as acetoxy group, octanoyloxy group, and benzoyloxy group, alkenyloxy groups such as vinyloxy group, isopropenyloxy group, and 1-ethyl-2-methylvinyloxy group, ketoxime groups such as dimethylketoxime group, methylethylketoxime group, and diethylketoxime group, amino groups such as dimethylamino group, diethylamino group, butylamino group, and cyclohexylamino group, aminoxy groups such as dimethylaminoxy group and diethylaminoxy group, amide groups such as aminoxy group, N-methylacetamide group, N-ethylacetamide group, and N-methylbenzamide group. Among these, the particularly preferred are alkoxy groups, and in particular, methoxy group and ethoxy group, and the most preferred is methoxy group.

The diorganopolysiloxane of the component (A) may preferably have a viscosity at 25° C. of 100 to 1,000,000 mPa·s, more preferably 300 to 500,000 mPa·s, still more preferably 500 to 100,000 mPa·s, and most preferably 1,000 to 80,000 mPa·s. A coating having high physical and mechanical strength may not be formed when the diorganopolysiloxane has a viscosity of less than 100 mPa·s. A viscosity in excess of 1,000,000 mPa·s results in the unduly high viscosity of the composition, and hence, poor workabilty in its use. The viscosity is the one measured by a rotary viscometer.

Examples of the diorganopolysiloxane of the component (A) include those represented by the following (a) to (f):

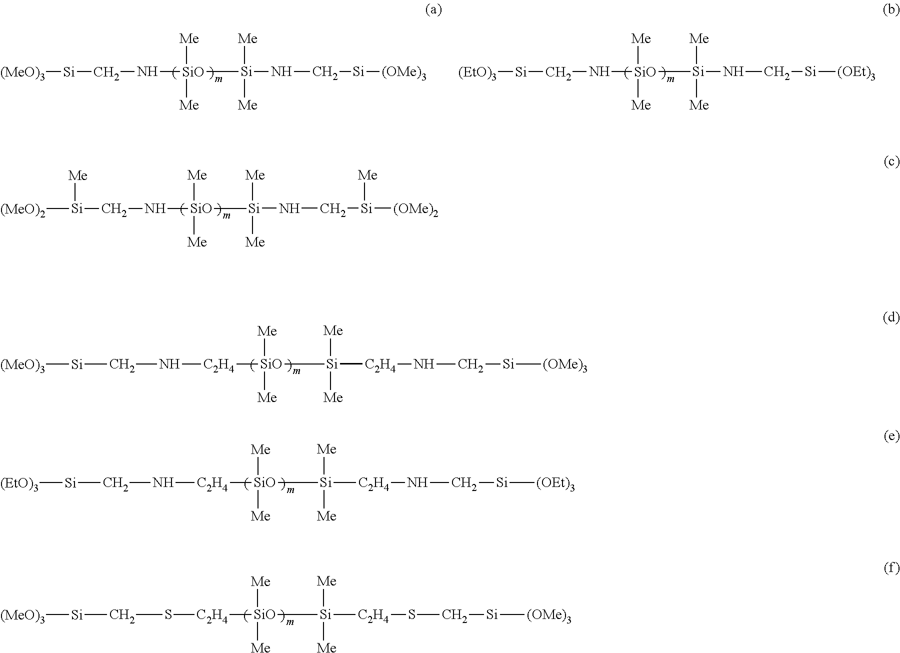

wherein Me is methyl group, Et is ethyl group, and m is as defined above.

The compounds of the types (a) to (c) may be obtained, for example, by dehydrochlorination of a dimethylpolysiloxane having chlorine atom at its opposite ends and an aminomethyltrialkoxysilane. The compounds of the types (d) and (e) may be obtained, for example, by reacting a dimethylpolysiloxane having vinyl group at its opposite ends with an aminomethyltrialkoxysilane. The compounds of type (f) may be produced by photoaddition of a dimethylpolysiloxane having vinyl group at its opposite ends with a mercaptomethyltrialkoxysilane.

The diorganopolysiloxane of the component (A) may be used alone or in combination of two or more diorganopolysiloxanes each having different structure and molecular weight.

The diorganopolysiloxane of the component (A) cures in the absence of a curing agent. However, inclusion of the curing agent of the component (B) is preferable for faster curing.

### Component (B)

A silane having at least 2 hydrolyzable groups bonded to the silicon atom per molecule and/or its partial hydrolytic condensate of the component (B) is the component for curing the composition of the present invention, and it should contain the at least 2 hydrolyzable groups bonded to the silicon atom per molecule. The silane is preferably the one represented by the following formula (3):

R¹_{c}SiY_{4-c} (3)

wherein R¹ is independently a substituted or unsubstituted monovalent hydrocarbon group containing 1 to 6 carbon atoms, Y is independently a hydrolyzable group, and c is an integer of 0 to 2.

The examples of the hydrolyzable group (Y) are the same as those described as the hydrolyzable group other than the hydroxy group at the end of the molecular chain of the organopolysiloxane of the component (A). The preferred are alkoxy group, ketoxime group, and isopropenoxy group.

The silane and/or its partial hydrolytic condensate of the component (B) is not particularly limited as long as it contains at least 2 hydrolyzable groups in its molecule as described above. Preferably, the silane and/or its partial hydrolytic condensate contains at least 3 hydrolyzable groups, and silicon atom may have a group other than the hydrolyzable group bonded thereto. The molecular structure may be either silane or siloxane structure, and in the case of the siloxane structure, it may be straight chain, branched, or cyclic.

R¹ which is a group other than the hydrolyzable group is a substituted or unsubstituted monovalent hydrocarbon group containing 1 to 6 carbon atoms, and examples include alkyl groups such as methyl group, ethyl group, propyl group, butyl group, pentyl group, and hexyl group, cycloalkyl groups such as cyclopentyl group and cyclohexyl group, aryl groups such as phenyl group and tolyl group, aralkyl groups such as benzyl group and 2-phenylethyl group, alkenyl groups such as vinyl group, allyl group, butenyl group, pentenyl group, and hexenyl group, and halogenated alkyl groups such as 3,3,3-trifluoropropyl group and 3-chloropropyl group. Among these, the preferred are methyl group, ethyl group, phenyl group, and vinyl group.

Examples of the silane and/or its partial hydrolytic condensate of the component (B) of the present invention include ethyl silicate, propyl silicate, methyltrimethoxysilane, methyltriethoxysilane, vinyltrimethoxysilane, vinyltriethoxysilane, methyltris(methoxyethoxy)silane, vinyltris(methoxyethoxy)silane, methyl tripropenoxysilane, methyltriacetoxysilane, vinyltriacetoxysilane, methyltri(methylethylketoxime)silane, vinyltri(methylethylketoxime)silane, phenyltri(methylethylketoxime)silane, propyltri(methylethylketoxime) silane, tetra(methylethylketoxime)silane, 3,3,3-trifluoropropyltri(methylethylketoxime)silane, 3-chloropropyl tri(methylethylketoxime)silane, methyltri(dimethylketoxime)silane, methyltri(diethylketoxime)silane, methyltri(methylisopropylketoxime)silane, tri(cyclohexanoxime)silane, and their partial hydrolytic condensates. These may be used alone or in combination of two or more.

The component (B) may be incorporated at an amount of typically 0 to 20 parts by weight, preferably 0.1 to 20 parts by weight, and more preferably 0.5 to 10 parts by weight in relation to 100 parts by weight of the component (A). An amount in excess of 20 parts by weight may result in unduly high hardness of the cured product or economic disadvantage.

### Component (C)

The component (C) is a filler, which is used for imparting sufficient mechanical strength to the cured product produced from this composition. The filler may be those known in the art such as fine powder silica, fumed silica, silica aerogel, precipitated silica, diatomaceous earth, metal oxide such as iron oxide, zinc oxide, and titanium oxide, any of these surface treated with a silane, metal carbonate such as calcium carbonate, magnesium carbonate, and zinc carbonate, asbestos, glass wool, carbon black, mica fine particles, molten silica powder, and powder of a synthetic resin such as polystyrene, polyvinyl chloride, or polypropylene.

The filler may be used at an amount of 1 to 400 parts by weight, and more preferably at 5 to 200 parts by weight in relation to 100 parts by weight of the component (A). When used at an amount less than 1 part by weight, the cured product produced from this composition is unlikely to exhibit a sufficient mechanical strength, and use in excess of 400 parts by weight will invite undesirable increase in the viscosity of the composition resulting in poor workability, and also, the cured product tends to exhibit poor rubber strength, and hence, insufficient rubber elasticity.

The diorganopolysiloxane of the component (A) cures without using the curing catalyst. However, incorporation of a curing catalyst is preferable for the promotion of the curing. The curing catalyst used may be a condensation catalyst, and more preferably, an organometallic catalyst (D).

### Component (D)

The component (D) is used for the curing of the composition. Exemplary organometallic catalysts include alkyltin ester compounds such as dibutyltin diaceate, dibutyltin dilaurate, and dibutyltin dioctoate; titanate esters or titanium chelate compounds such as tetraisopropoxytitanium, tetra-n-butoxytitanium, tetrakis(2-ethylhexoxy)titanium, titanium dipropoxybis(acetylacetonate), and titanium isopropoxy octylene glycol; and organometallic compounds such as zinc naphthenate, zinc stearate, zinc-2-ethyloctoate, iron-2-ethylhexoate, cobalt-2-ethylhexoate, manganese-2-ethylhexoate, cobalt naphthenate, alkoxyaluminium compound, bismuth tris(2-ethyl hexoate), and bismuth tris(neodecanoate).

Examples also include aminoalkyl group-substituted alkoxysilanes such as 3-aminopropyltriethoxysilane and N-2-(aminoethyl)-3-aminopropyltrimethoxysilane, amine compounds and their salts such as hexylamine and dodecylamine phosphate, quaternary ammonium salts such as benzyltriethylammonium acetate, lower fatty acid salts of an alkaline metal such as potassium acetate, sodium acetate, and lithium oxalate, dialkylhydroxylamine such as dimethylhydroxylamine and diethylhydroxylamine, and guanidyl group-containing silanes or siloxanes such as tetramethylguanidylpropyltrimethoxysilane, tetramethylguanidylpropylmethyldimethoxysilane, and tetramethylguanidylpropyltris(trimethylsiloxy)silane, which may be used alone or in combination of two or more.

The curing catalyst is typically incorporated at an amount of 0 to 20 parts by weight, preferably 0.001 to 15 parts by weight, and most preferably 0.01 to 5 parts by weight in relation to 100 parts by weight of the component (A).

The room temperature curable organopolysiloxane composition of the present invention may also contain known additives such as pigment, dye, antiaging agent, antioxidant, antistatic agent, flame retardant such as antimony oxide and paraffin chloride, and also, polyether as thixotropic agent, antimold agent, antimicrobial agent, and adhesion aid.

Examples of the adhesion aid include epoxysilanes such as 3-glycidoxypropyltrimethoxysilane and 2-(3,4-epoxycyclohexyl)ethyltrimethoxysilane, and isocyanate silane. The adhesion aid is preferably incorporated at an amount of 0.1 to 20 parts by weight, and in particular, 0.2 to 10 parts by weight in relation to 100 parts by weight of the component (A).

The organopolysiloxane composition of the present invention may be prepared by uniformly mixing predetermined amount of the components and additives as described above in a dry atmosphere.

The organopolysiloxane composition can be cured by leaving at room temperature. However, the method and conditions used for the molding and curing may be determined according to the type of the composition.

The resulting room temperature curable organopolysiloxane composition of the present invention cures by the moisture in the air at room temperature to form a cured rubber elastomer product having excellent heat resistance, weatherability, low temperature properties, and adhesion to various substrates, and in particular, to metals. In addition, the composition has particularly favorable storage stability and curability, and the composition rapidly cures by exposure to the air, for example, even after storing for 6 months to form a cured product having excellent physical properties. More specifically, the composition does not generate toxic or corrosive gas in the course of its curing, and also, the composition does not generate rusts on the surface to which the composition is coated. In particular, the composition is widely useful as an insulator and adhesive for electric and electronic components, and also, as a sealant, caulking agent, coating agent, and mold release agent for various substrates and as a fiber treating agent since the composition does not cause contact fault of the electric and electronic components.

### EXAMPLES

Next, the present invention is described in further detail by referring to Examples and Comparative Examples which by no means limit the scope of the present invention. Unless otherwise noted, “parts” means “parts by weight” and the viscosity is the one measured at 25° C. by a rotary viscometer. Me means methyl group.

### Example 1

100 parts of dimethylpolysiloxane represented by the following formula (I) having a viscosity of 30,000 mPa·s and 1 part of dibutyltin laurate were mixed while avoiding contact with moisture until the mixture was uniform to thereby prepare the composition.

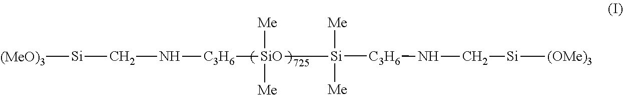

### Example 2

100 parts of dimethylpolysiloxane represented by the following formula (II) having a viscosity of 31,000 mPa·s and 1 part of dibutyltin laurate were mixed while avoiding contact with moisture until the mixture was uniform to thereby prepare the composition.

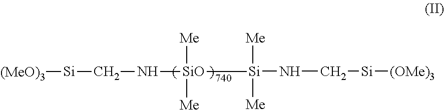

### Example 3

90 parts of dimethylpolysiloxane represented by the formula (I) having a viscosity of 30,000 mPa·s and 10 parts of fumed silica surface treated with dimethyldichlorosilane were uniformly mixed, and 5 parts of methyltrimethoxysilane, 0.3 part of dibutyltin dilaurate, and 1 part of 3-aminopropyltriethoxysilane were added while avoiding contact with moisture until the mixture was uniform to thereby prepare the composition.

### Comparative Example 1

The procedure of Example 1 was repeated except that 100 parts of the dimethylpolysiloxane represented by the formula(I) was replaced with 100 parts of the dimethylpolysiloxane represented by the formula (III) to prepare the composition.

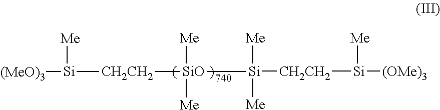

### Comparative Example 2

The procedure of Example 1 was repeated except that 100 parts of the dimethylpolysiloxane represented by the formula(I) was replaced with 100 parts of the dimethylpolysiloxane represented by the formula (IV) to prepare the composition.

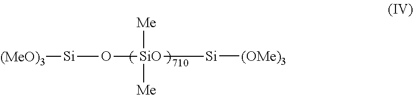

### Comparative Example 3

The procedure of Example 3 was repeated except that 100 parts of the dimethylpolysiloxane represented by the formula(I) was replaced with 100 parts of the dimethylpolysiloxane represented by the formula (III) to prepare the composition.

Next, the as-produced compositions obtained in Examples and Comparative Examples were extruded into a sheet having a thickness of 2 mm, and the sheet was exposed to an air at a temperature of 23° C. and relative humidity of 50%. Hardness after 1 hour was confirmed.

Cured sheets obtained by leaving the sheet in the same atmosphere for 7 days were evaluated for their physical properties (initial physical properties) according to JIS K-6249. The hardness was measured by using durometer A hardness tester according to JIS K-6249.

The cured sheet was stored in a thermo-hygrostat at a temperature of 85° C. and relative humidity of 85% for 100 hours, and the sheets were evaluated for their properties by the same procedure. A sheet having a thickness of 2 mm was also prepared from the each of the as-produced compositions obtained in the Examples and Comparative Examples which had been placed in a sealed container and left at a temperature of 70° C. for 7 days and the as-produced compositions which had been left at 23° C. for 6 months, and these sheets were also evaluated for their properties by the same procedure.

The results are shown in Table 1.

TABLE 1

| | | Example | | | Comparative Example | | |
|---|---|---|---|---|---|---|---|
| | | 1 | 2 | 3 | 1 | 2 | 3 |
| Initial | Curability | Pass | Pass | Pass | Fail | Pass | Fail |
| | Hardness (durometer A) | 10 | 11 | 25 | 10 | 12 | 24 |
| | Elongation at break (%) | 150 | 160 | 350 | 150 | 180 | 380 |
| | Tensile strength (MPa) | 0.2 | 0.2 | 1.5 | 0.2 | 0.2 | 1.4 |
| Storage test | Hardness (durometer A) | 10 | 10 | 26 | 10 | 9 | 24 |
| 70° C., 7 days | Elongation at break (%) | 150 | 170 | 380 | 160 | 210 | 410 |
| | Tensile strength (MPa) | 0.2 | 0.2 | 1.9 | 0.2 | 0.1 | 1.5 |
| Durability test | Hardness (durometer A) | 9 | 8 | 25 | 9 | 1 | 25 |
| 80° C., 80% RH | Elongation at break (%) | 170 | 180 | 380 | 200 | 650 | 400 |
| | Tensile strength (MPa) | 0.2 | 0.2 | 1.4 | 0.2 | 0.01 | 1.2 |
| Storage test | Hardness (durometer A) | 10 | 11 | 26 | 9 | 8 | 23 |
| 23° C., 6 months | Elongation at break (%) | 160 | 170 | 370 | 170 | 220 | 400 |
| | Tensile strength (MPa) | 0.2 | 0.2 | 1.8 | 0.2 | 0.1 | 1.3 |

Japanese Patent Application No. 2011-101233 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A room temperature curable organopolysiloxane composition comprising, as its main component, a diorganopolysiloxane having at least two groups represented by the following formula (1): 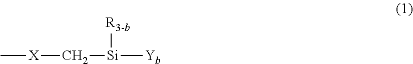
wherein X is —R′_{d}—NH— or —R′_{d}—S—, R is a substituted or unsubstituted monovalent hydrocarbon group containing 1 to 12 carbon atoms, R′ is a divalent hydrocarbon group containing 1 to 8 carbon atoms, Y is a hydrolyzable group, b is 2 or 3, and d is 0 or 1 per molecule.

2. A room temperature curable organopolysiloxane composition according to claim 1 wherein the diorganopolysiloxane of the component (A) is the one represented by the following formula (2): 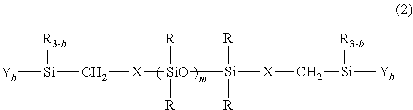
wherein X, R, Y, and b as defined above, and m is a number such that viscosity of the diorganopolysiloxane at 25° C. is 100 to 1,000,000 mPa·s.

3. A room temperature curable organopolysiloxane composition according to claim 1 further comprising
(B) a silane having at least 2 hydrolyzable groups bonded to the silicon atom per molecule and/or its partial hydrolytic condensate.

4. A room temperature curable organopolysiloxane composition according to claim 1 further comprising
(C) a filler.

5. A room temperature curable organopolysiloxane composition according to any one of claims 1 to 4 further comprising
(D) an organometallic catalyst.

6. A structure produced by using the room temperature curable organopolysiloxane composition of any one of claims 1 to 5.
